(19) United States
(12) Patent Application Publication
(10) Pub. No.: US 2010/0015365 A1
(43) Pub. Date: Jan. 21, 2010

(54) Tree Protector

(75) Inventors: Scott P. Greelis, Moorhead, MN (US); Paul A. Malmanger, Fargo, ND (US); Jim A. Larson, Fargo, ND (US)

Correspondence Address: FISH & RICHARDSON P.C., PO BOX 1022, MINNEAPOLIS, MN, 55440-1022, US

(73) Assignee: COMPOSITE AMERICA, LLC, Fargo, ND (US)

(21) Appl. No.: 12/490,021

(22) Filed: Jun. 23, 2009

Related U.S. Application Data
(60) Provisional application No. 61/082,412, filed on Jul. 21, 2008.

(51) Int. Cl. A01N 3/00

(52) U.S. Cl. 428/18

(57) ABSTRACT

A tree protector and a process of making the tree protector are described. The tree protector includes a natural fiber composite where natural fibers are bonded together by a polymer binder.

### CROSS REFERENCE TO RELATED APPLICATIONS

This application claims priority under 35 USC §119(e) to U.S. Provisional Patent Application Ser. No. 61/082,412, filed on Jul. 21, 2008, the entire contents of which are hereby incorporated by reference.

### TECHNICAL FIELD

This disclosure relates to a tree protector and a process for making the same.

### BACKGROUND

Trees have a thin layer of cambium that lies just beneath the bark. The cambium layer transports water and nutrients to and from the roots and leaves. It also produces new wood and bark tissue as trees grow. Anything that damages the bark or the underlying cambium layer can weaken trees and make them more vulnerable to disease and insects.

Tree trunks can be damaged by weather, animals and equipment. For example, sunscald or frost cracking may be caused by above-average temperatures in the winter or early spring. In the winter, when other foods are scarce, moles, mice and rabbits may eat the bark of young trees. Careless use of lawn mowers, weed trimmers and other equipment can also damage tree trunks.

Tree protectors or guards can increase the survival rate of young trees by protecting the trunks from damage caused by weather, animals and equipment. Some tree protectors protect young trees by moderating extreme temperatures or reflecting sunlight. Some tree protectors protect young trees by blocking small mammals from them. Some tree protectors protect young trees by reducing abrasion and making them easier to see.

There are many types of tree protectors. For example, tree protectors can be extruded corrugated pipes that are made from polyethylene, poly(vinyl chloride) or other thermoplastics. Tree protectors can also die cut thermoplastic sheets that are rolled into a tube shape.

### SUMMARY

A tree protector is described that includes a natural fiber composite where natural fibers are bonded together by a polymer binder. In some embodiments, the tree protector includes a printed film to provide a bark appearance. In some embodiments, the natural fiber composite includes multiple layers. The natural fibers may include bast fibers that may include hemp, kenaf, jute, flax, banana, or combination thereof. The polymer binder may include a thermoplastic polymer, a thermosetting polymer, or combination thereof. In some embodiments, the thermoplastic binder includes a polypropylene. In some embodiments, the polymer binder includes a biopolymer resin that may include a biodegradable aliphatic polyester, a resin that is derived from a vegetable oil or sugar, or combination thereof. In some embodiments, the biodegradable aliphatic polyester comprises a polylactic acid (PLA). In some embodiments, the biopolymer resin is derived from a soy polyol. In some embodiments, the biopolymer resin includes a poly(sugar acrylate).

### DESCRIPTIONS OF THE DRAWINGS

FIG. 1 shows an exemplary embodiment of a tree protector; and

FIG. 2 shows an exemplary method for making a tree protector.

Like reference symbols in the various drawings indicate like elements.

### DETAILED DESCRIPTION

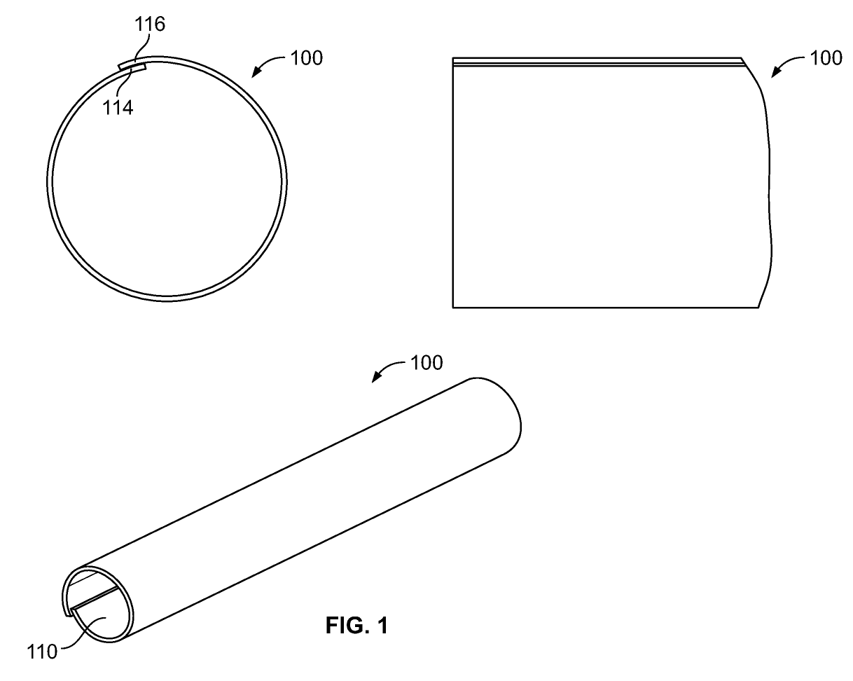

FIG. 1 illustrate an exemplary embodiment of a tree protector 100. The tree protector 100 is made from a sheet of natural fiber composite 110. In some implementations, the composite sheet 110 has a multi-layered structure. The composite sheet 110 is self-bonded together at its two lateral edges 114, 116 after it is rolled into a tube shape. The composite sheet 110 may be self-bonded together at its two lateral edges 114, 116 using any suitable methods. For example, the composite sheet 110 may be self-bonded together by impregnating the mating surfaces of its two lateral edges 114, 116 with a suitable amount of a polymer binder, followed by solidifying or curing while the two edges 114, 116 are pressed together to form adequate bonding therebetween. The tree protector 100 may have various diameters and/or lengths. In some implementations, the tree protector 100 is combined with a decorative film that can enhance the appearance of the tree protector 100. For example, a printed film may be added over the tree protector 100 to provide an appearance of bark.

The natural fiber composite includes natural fibers that are bonded together by a polymer binder. Natural fibers include plant-derived fibers. Representative examples of suitable plant-derived fibers include bast fibers. Bast fibers refer to strong woody fibers obtained chiefly from the phloem of plants. Representative examples of suitable bast fibers include jute, kenaf, hemp, flax, banana, ramie, roselle, and combinations thereof. Other examples of suitable bast fibers include leaf fibers (e.g., fibers derived from sisal, banana leaves, grasses (e.g., bamboo), or pineapple leaves), straw fibers (e.g., fibers derived from wheat straw, rice straw, barley straw, or sorghum stalks), and husk fibers (e.g., fibers derived from corn husk, bagasse (sugar cane), or coconut husk).

The natural fiber composite can contain any suitable amount of the natural fibers. In some embodiments, the natural fibers are about 20 wt % to about 80 wt % of the total weight of the composite. For example, the natural fibers may be greater than about 25 wt %, about 35 wt %, about 65 wt % or about 75 wt % of the total weight of the composite. In some embodiments, the natural fibers are about 30 wt % to about 70 wt % of the total weight of the composite. For example, the natural fibers may be greater than about 40 wt %, about 50 wt % or about 60 wt % of the total weight of the composite. In some embodiments, the natural fibers are about 40 wt % to about 60 wt % of the total weight of the composite. For example, the natural fibers may be greater than about 45 wt % or about 55% of the total weight of the composite.

The natural fibers used in the natural fiber composite can have any suitable linear density (i.e., denier). For example, the natural fibers can have a linear density of about 8 denier to about 18 denier.

The polymer binder used in the natural fiber composite can be any suitable polymer binder. For example, the polymer binder can be a thermoplastic polymer that is capable of at least partially softening or melting when heated so that the natural fibers can be bonded together to form the natural fiber composite. Representative examples of suitable thermoplastic binders include polyester (e.g., polyethylene terephthalate (PET) or glycol-modified PET (PETG)), polyamide (e.g., nylon 6 or nylon 6,6), polyethylene (e.g., high density polyethylene (HDPE) or linear low density polyethylene (LLDPE)), polypropylene, poly(1,4-cyclohexanedimethylene terephthalate) (PCT), and combinations thereof. In some embodiments, the polymer binder includes virgin or recycled polypropylene which has relatively high bonding performance.

Suitable thermoplastic binders, such as polyolefins, can contain coupling, compatibilizing, and/or mixing agents. These agents may improve the interaction and/or bonding between the natural fibers and the thermoplastic binder, thereby yielding a natural fiber composite that may have better mechanical properties. Representative examples of suitable coupling, compatibilizing, and/or mixing agents include titanium alcoholates; esters of phosphoric, phosphorous, phosphonic and silicic acids; metallic salts and esters of aliphatic, aromatic and cycloaliphatic acids; ethylene/acrylic or methacrylic acids; ethylene/esters of acrylic or methacrylic acid; ethylene/vinyl acetate resins; styrene/maleic anhydride resins or esters thereof, acrylonitrilebutadiene styrene resins; methacrylate/butadiene styrene resins (MBS), styrene acrylonitrile resins (SAN); butadieneacrylonitrile copolymers; and polyethylene or polypropylene modified polymers. Such polymers are modified by a reactive group including polar monomers such as maleic anhydride or esters thereof, acrylic or methacrylic acid or esters thereof, vinylacetate, acrylonitrile, and styrene. In some embodiments, the thermoplastic binder includes a polyolefin (e.g., polyethylene or polypropylene) or a copolymer thereof that has maleic anhydride (MAH) grafted thereon.

The coupling, compatibilizing, and/or mixing agents can be present in the thermoplastic binder in any suitable amount. For example, the agents can be present in the thermoplastic binder in an amount of about 0.01 wt % or more, about 0.1 wt % or more, or about 0.2 wt % or more, based on the total weight of the binder. The agents can also be present in the thermoplastic binder in an amount of about 20 wt % or less, about 10 wt % or less, or about 5 wt % or less, based on the total weight of the binder. In some embodiments, the thermoplastic binder contains about 0.01 to about 20 wt % or about 0.1 to about 10 wt % of the coupling, compatibilizing, and/or mixing agents, based on the total weight of the binder. The amount of coupling, compatibilizing, and/or mixing agents can also be expressed in term of the number of moles of the coupling, compatibilizing, and/or mixing agents present per mole of the thermoplastic binder. In some embodiments, such as when the thermoplastic binder comprises polypropylene and a maleic anhydride coupling agent, the binder can contain about 5 to about 50 moles of maleic anhydride per mole of the polypropylene polymer.

The polymer binder can also be a thermosetting polymer that when cured is capable of bonding the natural fibers together to form the natural fiber composite. Representative examples of suitable thermosetting binders include polyurethane, epoxy, phenolic and urea.

In some embodiments, the polymer binder includes a biopolymer resin. One representative example of suitable biopolymer resins is biodegradable aliphatic polyesters. Representative examples of suitable biodegradable aliphatic polyesters includes polyesteramides, modified polyethylene terephthalate, polylactic acid (PLA), terpolymers based on polylactic acid, polyglycolic acid, polyalkylene carbonates (such as polyethylene carbonate), polyhydroxyalkanoates (PHA) (e.g., polyhydroxybutyrates (PHB), polyhydroxyvalerates (PHV), polyhydroxybutyrate-hydroxyvalerate copolymers (PHBV), homopolymers and copolymers thereof, combinations thereof), and the like. Other examples of suitable biodegradable aliphatic polyesters include aliphatic polyesters with repeating units of at least 5 carbon atoms (e.g., polycaprolactone), and succinate-based aliphatic polymers (e.g., polybutylene succinate, polybutylene succinate adipate, and polyethylene succinate). More examples of suitable biodegradable aliphatic polyesters include polyethylene oxalate, polyethylene malonate, polyethylene succinate, polypropylene oxalate, polypropylene malonate, polypropylene succinate, polybutylene oxalate, polybutylene malonate, polybutylene succinate, polyethylenedecane dioate and polyethylenetridecane dioate and copolymers of these compounds and a diisocyanate or a lactide.

In some embodiments, the biodegradable aliphatic polyester includes a polylactic acid (PLA) resin which has excellent heat resistance and hardness and can reliably bond the natural fibers. Polylactic acid refers to homopolymers of lactic acid, such as poly(L-lactic acid); poly(D-lactic acid); and poly(DL-lactic acid), as well as copolymers of lactic acid containing lactic acid as the predominant component and a small proportion of a copolymerizable comonomer, such as 3-hydroxybutyrate, caprolactone, glycolic acid, and the like. In some embodiments, the polylactic acid includes an additive such as flame retardant, antistatic agent or antioxidant.

Polylactic acid can be prepared by the polymerization (e.g., polycondensation or ring-opening polymerization) of lactic acid or lactide. In polycondensation, L-lactic acid, D-lactic acid, or a mixture thereof may be directly subjected to dehydro-polycondensation. In ring-opening polymerization, a lactide that is a cyclic dimer of lactic acid may be subjected to polymerization with the aid of a polymerization-adjusting agent and catalyst. The lactide may include L-lactide, D-lactide, and DL-lactide (a condensate of L-lactic acid and D-lactic acid). Each of these lactides (i.e., L-lactide, D-lactide, and DL-lactide) is a dimer; that is, they are comprised of two lactic acid units. As a result of its chiral center, lactic acid has two different stereochemical isomers; R isomer and S isomer configurations. D-lactide includes two R isomers, L-lactide includes two S isomers, and DL-lactide includes an R isomer and an S isomer. The various isomers may be mixed and polymerized, if necessary, to obtain polylactic acid having any desired composition and crystallinity. A small amount of a chain-extending agent (e.g., a diisocyanate compound, an epoxy compound or an acid anhydride) may also be employed to increase the molecular weight of the polylactic acid. In some embodiments, the weight average molecular weight of the polylactic acid is within the range of about 60,000 to about 1,000,000.

Lactic acid and lactide are asymmetrical molecules; they have two optical isomers, one is the levorotatory (“L”) enantiomer and the other is the dextrorotatory (“D”) enantiomer. By polymerizing a particular enantiomer or by using a mixture of the two enantiomers, it is possible to prepare different polymers that are chemically similar yet have different properties. In particular, by modifying the stereochemistry of a polylactic acid polymer in this manner it is possible to control, for example, the melting temperature, melt rheology, and crystallinity of the polymer.

The biopolymer resins may be derived from a vegetable oil such as soy oil. In some embodiments, the biopolymer resin is derived from a soy polyol. Soy polyols can be prepared by reacting maleated or fumarated soybean oils with polyols such as ethylene glycol, pentaerythritol, and trimethyl propane, and the like and their salts.

The biopolymer resins may also be derived from a sugar. Representative examples of suitable sugars include monosaccharides such as glucose, mannose and fructose; disaccharides such as sucrose, lactose, maltose, trehalose; and trisaccharides such as raffinose. In some embodiments, the biopolymer resin includes a poly(sugar acrylate). Poly(sugar acrylates) can be prepared by addition polymerization of sugar acrylate that can be produced by reacting a mixture of sugar and acrylate in an organic solvent in the presence of an enzyme.

Other examples of suitable biopolymer resins include plant-based compounds such as acetyl cellulose resins and chemically modified starch resins.

The natural fiber composite may be prepared as follows. Unordered natural fibers are first carded manually or by a machine so as to order the natural fibers and remove the tangles. In the carding process, raw or washed natural fibers are brushed to produce webs of natural fibers. The carding process can mix different types of natural fibers together and create a homogeneous mixture thereof. After the natural fibers are carded, the resultant webs of natural fibers are cross-lapped to produce nonwoven battings of natural fibers. The natural fibers are then blended with a suitable amount of a polymer binder, followed by laying the mixture in a mat that is air or dry needle punched so as to stitch together by mechanically interlocking and orienting the fibers and by densifying the web to produce a finished configuration. The web is then heated to a temperature sufficient to activate the polymer binder. The polymer binder binds the natural fibers together, producing a dimensionally stable web. In some embodiments, the nonwoven web is not compressed during the polymer binder activation process; alternatively, some degree of compression of the web may be used.

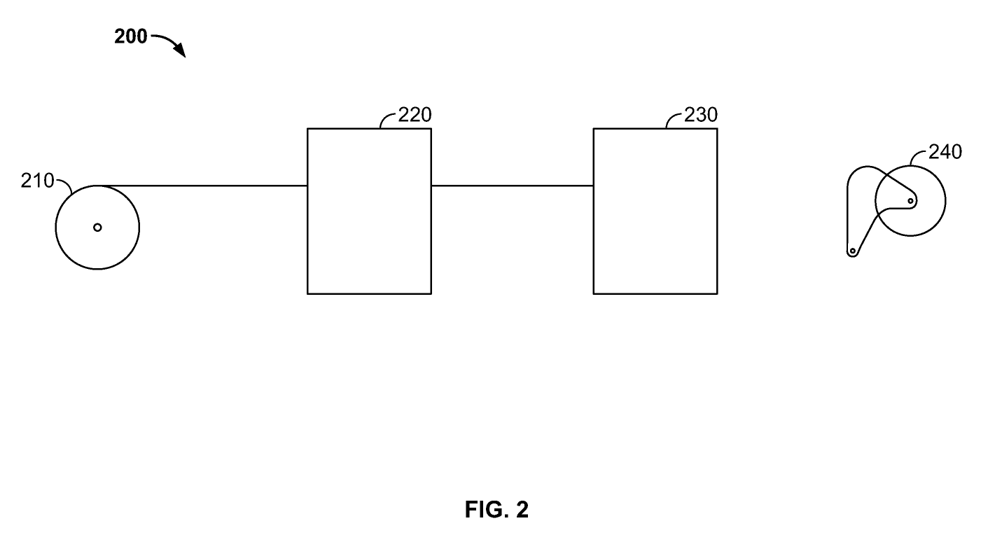

FIG. 2 illustrates an exemplary process 200 for making a tree protector. The process 200 includes impregnating with a binder polymer the mating surfaces of a natural fiber composite sheet and a printed film, heating the composite sheet and the printed film to activate the binder polymer, wrapping the materials around a cooled mandrel to produce either a long, slit open tube or a spiral wrapped tube and to permanently bond the composite sheet and the printed film together, removing the mandrel after the composite sheet and the printed film are bonded together, and cutting the bonded composite sheet/printed film to desired length. Natural fiber composite roll 210 may feed into a heater 220 a sheet of natural fiber composite and a printed film that are impregnated with a binder polymer. The heater 220 is heated to a predetermined temperature so as to activate the polymer binder to form a construct of composite sheet and printed film. The construct is then fed into a roller and cooling station 230 where the construct is wrapped around a cooled mandrel to form a tube. The roller and cooling station 230 may apply pressure to press the composite sheet and the printed film firmly together. The binder polymer is then allowed to solidify or cure for a predetermined time so that adequate bonding is formed between the composite sheet and the printed film. After the composite sheet and the printed film are permanently bonded together, the formed part is cut to proper length at a cut off station 270 to provide a finished tree protector. The finished tree protector has biodegradability that can reduce the environmental load on final disposal.

A number of embodiments of the invention have been described. Nevertheless, it will be understood that various modifications may be made without departing from the spirit and scope of the invention. Accordingly, other embodiments are within the scope of the following claims.

What is claimed is:

1. A tree protector comprising a natural fiber composite that includes natural fibers that are bonded together by a polymer binder.

2. The tree protector of claim 1 further comprising a printed film to provide a bark appearance.

3. The tree protector of claim 1, wherein the natural fiber composite comprises a multi-layered structure.

4. The tree protector of claim 1, wherein the natural fibers comprise bast fibers.

5. The tree protector of claim 4, wherein the bast fibers are selected from the group consisting of hemp, kenaf, jute, flax, banana, and combinations thereof.

6. The tree protector of claim 1, wherein the polymer binder comprises a thermoplastic polymer.

7. The tree protector of claim 6, wherein the thermoplastic polymer comprises a polypropylene.

8. The tree protector of claim 1, wherein the polymer binder comprises a thermosetting polymer.

9. The tree protector of claim 1, wherein the polymer binder comprises a biopolymer resin.

10. The tree protector of claim 9, wherein the biopolymer resin comprises a biodegradable aliphatic polyester.

11. The tree protector of claim 10, wherein the biodegradable aliphatic polyester comprises a polylactic acid (PLA).

12. The tree protector of claim 9, wherein the biopolymer resin is derived from a soy polyol.

13. The tree protector of claim 9, wherein the biopolymer resin is derived from a sugar.

14. The tree protector of claim 13, wherein the biopolymer comprises a poly(sugar acrylate).
